(19) United States
(12) Patent Application Publication
(10) Pub. No.: US 2015/0222974 A1
(43) Pub. Date: Aug. 6, 2015

(54) HAT CLIP WITH IMPROVED SPEAKERS

(71) Applicant: Ron Johnson, Pasadena, CA (US)

(72) Inventor: Ron Johnson, Pasadena, CA (US)

(21) Appl. No.: 14/485,652

(22) Filed: Sep. 12, 2014

Related U.S. Application Data
(60) Provisional application No. 61/877,243, filed on Sep. 12, 2013.

(51) Int. Cl. H04R 1/02

(52) U.S. Cl. CPC H04R 1/025; H04R 2420/07

(57) ABSTRACT

A helmet speaker system includes two small side-firing high fidelity speakers and an electronics package contained in a small water resistant plastic housing. Microphones are located close to one or more of the speakers. The speakers, microphone and electronics package are detachable from their respective helmet base mounts to enable the system to be moved from one helmet to the next. The side-firing speakers are positioned vertically, so that the sound is directed generally downward from the speaker when the speakers are attached to a helmet or hat at a location that is above the ear. The side-firing speakers have a very thin profile when viewed from the rider's front.

### CROSS-REFERENCE TO RELATED APPLICATION(S)

This application claims priority to and the benefit of U.S. Provisional Patent Application Ser. No. 61/877,243, filed on Sep. 12, 2013, the entire contents of which are incorporated herein by reference.

### SUMMARY

The invention relates to the problem of safely listening to music while riding a bicycle or engaging in other outdoor activities that take place near automobiles and other moving vehicles. Currently, to listen to music or other audio, cyclists typically ride with earphones in one or both ears. This creates a safety concern by isolating the user from the surrounding environment. So much so that many states have laws against riding a bicycle with earphones in both ears and some states disallow earphones completely. Furthermore, earphones require a wire to connect the actual speaker placed in the ear cannel to the music player. This wire is at best an annoyance and at worst a safety issue when is restricts the user's movement.

An embodiment of the system consists of two small side-firing high fidelity speakers and an electronics package contained in a small water resistant plastic housing. Microphones are located close to one or more of the speakers. Optionally offered is a small chinstrap mounted microphone so that the cyclist can use their cell phone in a hands free manner while riding. The speakers, microphone and electronics package are detachable from their respective helmet base mounts to enable the system to be moved from one helmet to the next. This is especially beneficial when the customer utilizes different helmets for different types of cycling or weather conditions. It also allows the removal of the system when washing the helmet.

The side-firing speakers are positioned vertically, so that the sound is directed generally downward from the speaker when the speakers are attached to a helmet or hat at a location that is above the ear. The use of side-firing speakers allows the speaker housing to be exceptionally thin, which among other things, reduces wind noise, reduces the likelihood of being dislodged from the helmet or hat or broken due to accidently hitting or being hit by something, and makes the system more unobtrusive.

Within the electronics package is a Bluetooth 3.0 receiver, a stereo amplifier, and a lithium-ion battery. The battery provides sufficient power to operate the system in play mode for up to 8 hours and standby for up to 400 hours.

Music is played by pairing the speaker unit with any Bluetooth 3.0 compatible device. This includes the popular Apple iPhone/iPod and most Android or Windows powered mobile devices. With the device synched to the speaker unit the user simply selects the speaker system from the device and adjusts the volume. When used with a smart phone this even allows the cyclist to enjoy music streamed from services like Pandora. Some embodiments include a handlebar mounted wireless volume control.

In an alternative embodiment, the unit is hat-mounted so that is usable in activities that do not require a helmet, such as running, jogging, and walking. This would offer the same safety benefits as the cycling helmet embodiments but also eliminate the annoyance of the dangling wire and self-ejecting earphones.

### BRIEF DESCRIPTION OF THE DRAWINGS

FIG. 1 is a diagram of an embodiment of a speaker system, with the right speaker housing shown in exploded view.

FIG. 2 is a photograph showing a side view of an embodiment of a speaker system as it may be connected to a hat.

FIG. 3 is a photograph showing a rear view of an embodiment of a speaker system as it may be connected to a hat.

FIG. 4 is a diagram of an embodiment of a speaker system shown in exploded view.

FIG. 5 is a diagram of an embodiment of a speaker system, with the right speaker housing shown in exploded view.

FIG. 6 is a diagram showing a side view of an embodiment of a speaker system as it may be connected to a helmet.

FIG. 7 is a diagram showing a side view of an embodiment of a speaker system as it may alternately be connected to a helmet.

FIG. 8 is an upward looking perspective view, exploded drawing of an embodiment of a speaker system.

FIG. 9 is a downward looking perspective view drawing of an embodiment of a speaker system.

### DETAILED DESCRIPTION

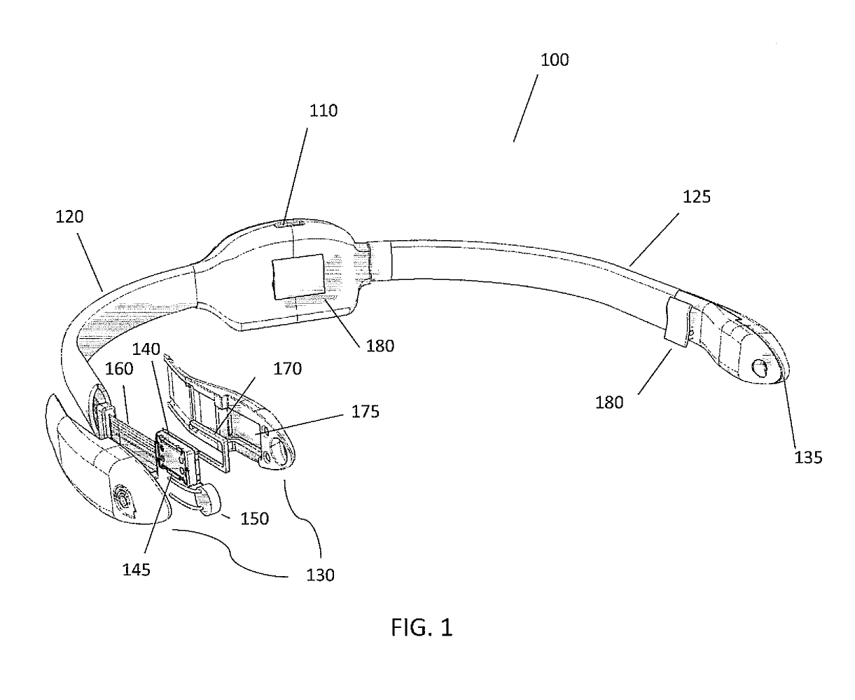

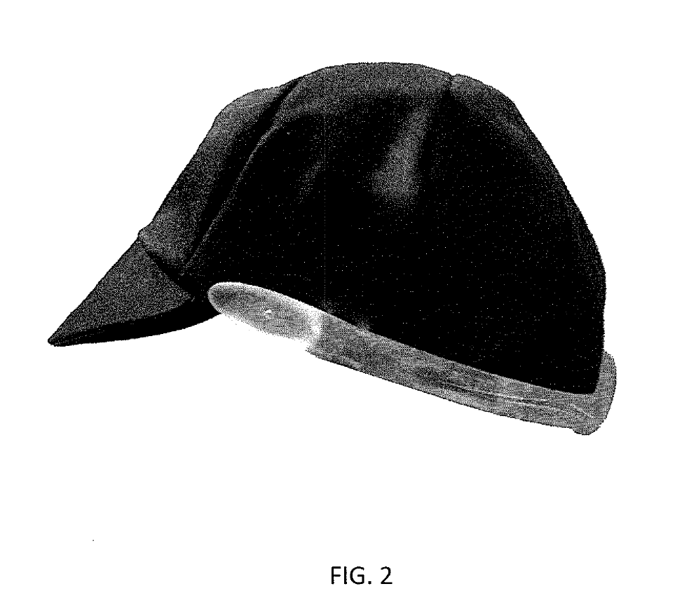

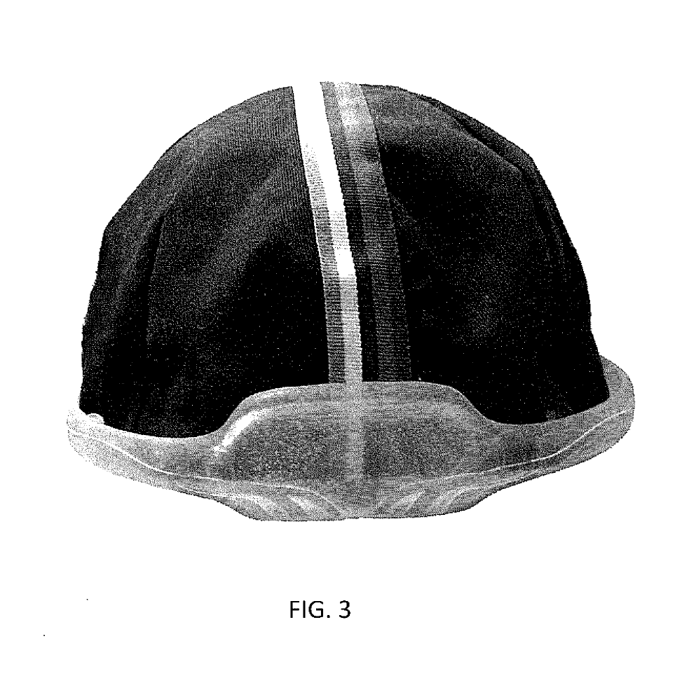

An embodiment according to the invention is shown in FIG. 1. A speaker system 100 includes an electronics body 110 connected to a right arm 120 and a left arm 125. At the end of the left arm 125 is a left speaker housing 135. A right speaker housing 130, shown in exploded view in FIG. 1, is at the end of the right arm 120. Each speaker housing includes a speaker 140 and a microphone 150. In some embodiments, however, no microphone is included or a microphone is only included in one of the speaker housings. The speakers 140 and microphones 150 are electrically connected to electronics (not shown) in the electronics body 110 by wire tape 160. Speaker 140 is a side firing speaker in which the sound produced by the speaker 140 is directed out of the narrow bottom edge 145 of the speaker 140. Speaker 140 and speaker baffle 170 fit inside a speaker chamber 175 within each speaker housing 130/135. The speaker housing 130/135, speaker 140, and speaker baffle 170 form a back cavity that improves the sound and performance of the speaker. The speaker system 100 also includes one or more clips 180 for attaching the speaker system 100 to, for example, the lower edge of a hat. An embodiment according to the invention is shown in FIGS. 2 and 3 as it may be positioned relative to a hat using clips 180.

In many embodiments the speakers are model RA11x15 speakers with side venting manufactured by Knowles Electronics. The use of side-firing speakers such as the Knowles model RA11x15 speakers allows for a very thin speaker housing which, among other things, reduces wind noise, reduces the likelihood of hitting or being hit by something, and makes the speaker system more unobtrusive.

In many embodiments the electronics in the electronics body 110 include (now shown), a battery, a Bluetooth receiver, a digital to audio converter and an amplifier. In many embodiments the speaker system 100 includes buttons (shown in other figures) for controlling operations of the speaker system such as volume and Bluetooth pairing. Alternatively or additionally, the same or additional buttons also control operations of a portable audio device, such as play/pause, forward/reverse, and skip track forward/reverse. The portable audio device may include an mp3 player, smart phone, or tablet. In some embodiments, some or all of the buttons are provided in a wireless module that may be mounted, for example, on the handlebars of a bicycle. In some embodiments the wireless connection is a dedicated wireless connection between the button module and the speaker system. In some embodiments the wireless connection is a Bluetooth connection separate from the Bluetooth connection between the speaker system and the portable audio device. In some embodiments the wireless connection is a Bluetooth connection directly between the button module and the portable audio device.

In some embodiments, the speaker system 100 does not have buttons for controlling operations of the speaker system. In many of these embodiments, the operations of the speaker system are controlled by voice commands. In such embodiments, the electronics in electronics body 510 include a processor that performs voice recognition functions. By using voice commands, the user of the speaker system is able to control the speaker system and the portable audio device with using their hands, allowing them, in the case of a cyclist, to keep both hands on the handlebars. In some embodiments the voice recognition function is performed by the portable audio device connected to the speaker system rather than by the electronics of the speaker system. In some embodiments, the portable audio device includes an application that will send commands back to the speaker system (such as volume up or down or mute) based on the results of the voice recognition performed by the portable audio device. In some embodiments the voice input received from the speaker system is sent by the portable audio system to a cloud-based application which performs the speech recognition function.

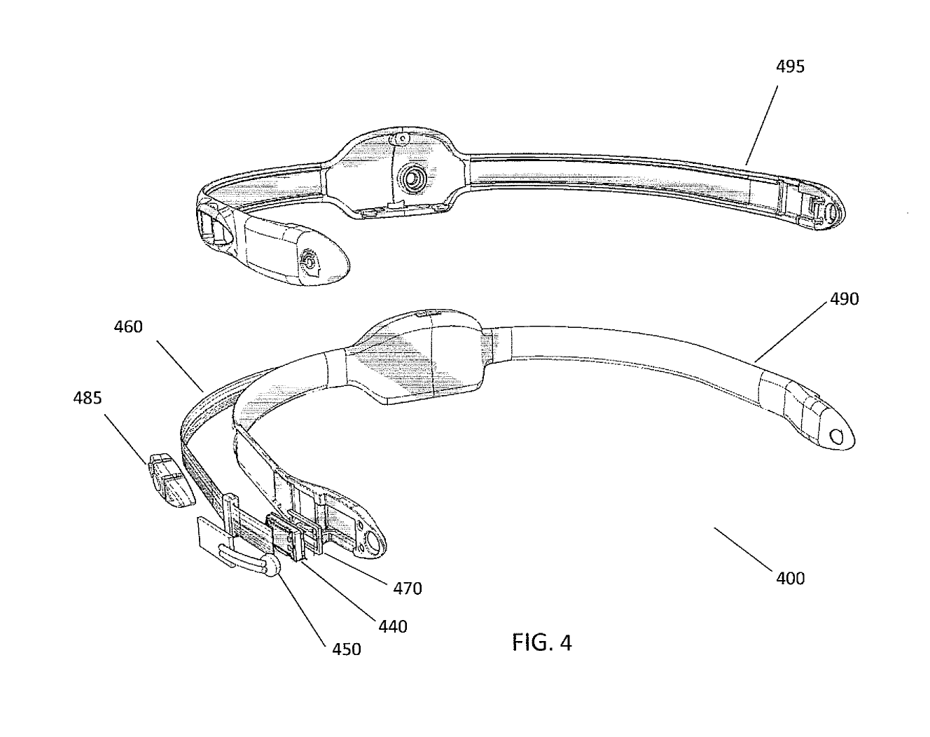

An embodiment according to the invention is shown in FIG. 4. The speaker system 400 shown in FIG. 4 generally corresponds to the speaker system 100 shown in FIG. 1. The speaker system 400 is shown in an exploded view that separately shown an inner housing 490 and an outer housing 495. Fitting between the inner housing 490 and the outer housing 495 are speaker 440, speaker baffle 470, wire tape 460, microphone 450, and buttons 485. In some embodiments inner housing 490 and outer housing 495 snap together. In some embodiments inner housing 490 and outer housing 495 are connected to each other by screws. In some embodiments inner housing 490 and outer housing 495 are connected by a combination of snapping and screws.

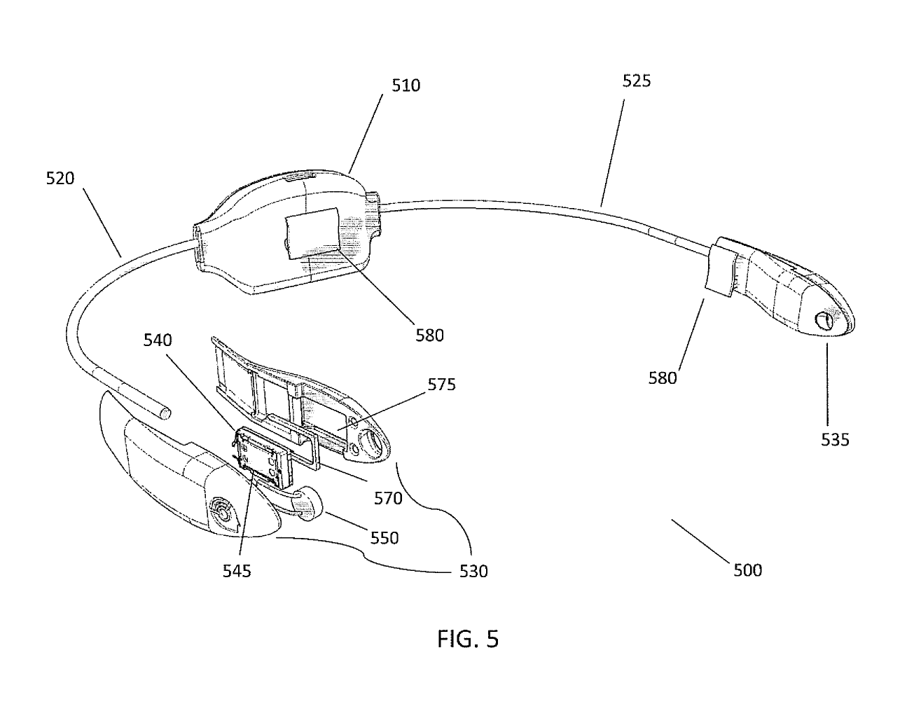

An embodiment according to the invention is also shown in FIG. 5. The speaker system 500 shown in FIG. 5 also generally corresponds to the speaker system 100 and speaker system 400 shown in FIGS. 1 and 4. Accordingly. Speaker system 500 includes an electronics body 510 connected to a right cable 520 and a left cable 525. At the end of the left cable 525 is a left speaker housing 535. A right speaker housing 530, shown in exploded view in FIG. 5, is at the end of the right cable 520. Each speaker housing includes a speaker 540 and a microphone 550. In some embodiments, however, no microphone is included or a microphone is only included in one of the speaker housings. The speakers 540 and microphones 550 are electrically connected to electronics (not shown) in the electronics body 510 by wires (not shown) in cables 520/525. Speaker 540 is a side firing speaker in which the sound produced by the speaker 540 is directed out of the narrow bottom edge 545 of the speaker 540. Speaker 540 and speaker baffle 570 fit inside a speaker chamber 575 within each speaker housing 530/535. The speaker housing 530/535, speaker 540, and speaker baffle 570 form a back cavity that improves the sound and performance of the speaker.

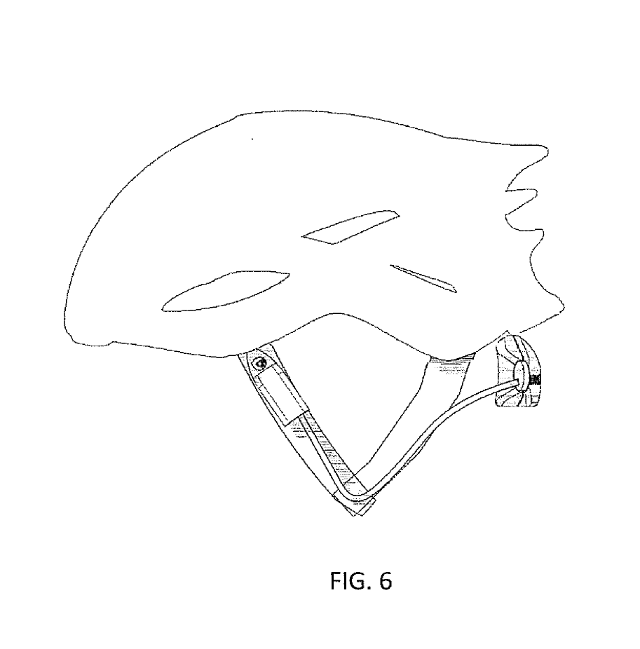

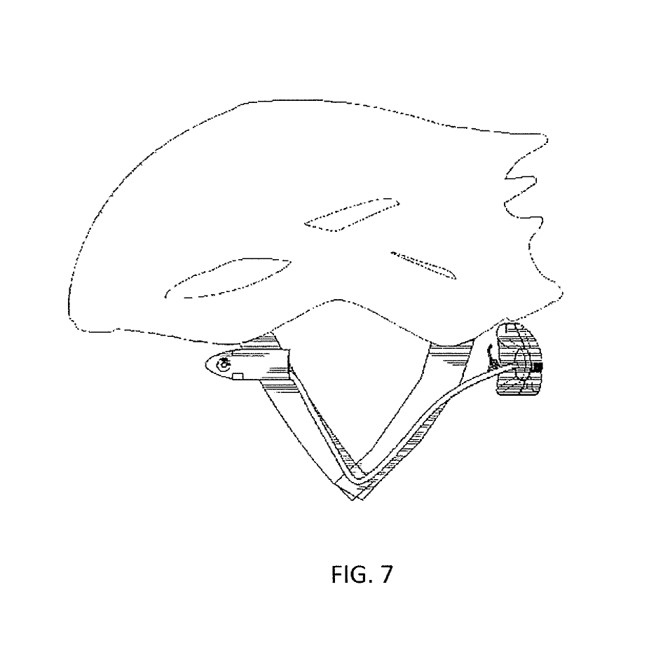

The speaker system 500 also includes one or more clips 180 for attaching the electronics body 510 and the speaker housings 530, 535 to, for example, a bicycle helmet. An embodiment according to the invention is shown in FIGS. 6 and 7 as the electronics body and a speaker housing may be positioned relative to a bicycle helmet using clips 580. FIGS. 6 and 7 both show a speaker housing clipped to one of the straps that go under a riders chin to hold the helmet in place. FIGS. 6 and 7 show two different exemplary ways in which a speaker housing may be clipped to a strap of a bicycle helmet.

In many embodiments the speakers are model RA11x15 speakers with side venting manufactured by Knowles Electronics as described above in more detail.

In many embodiments the electronics in the electronics body 510 include (now shown), a battery, a Bluetooth receiver, a digital to audio converter and an amplifier. In many embodiments the speaker system 500 includes buttons (not shown) for controlling operations of the speaker system such as volume and Bluetooth pairing and alternatively or additionally, controlling operations of a portable audio device, such as play/pause, forward/reverse, and skip track forward/reverse, as described more completely above.

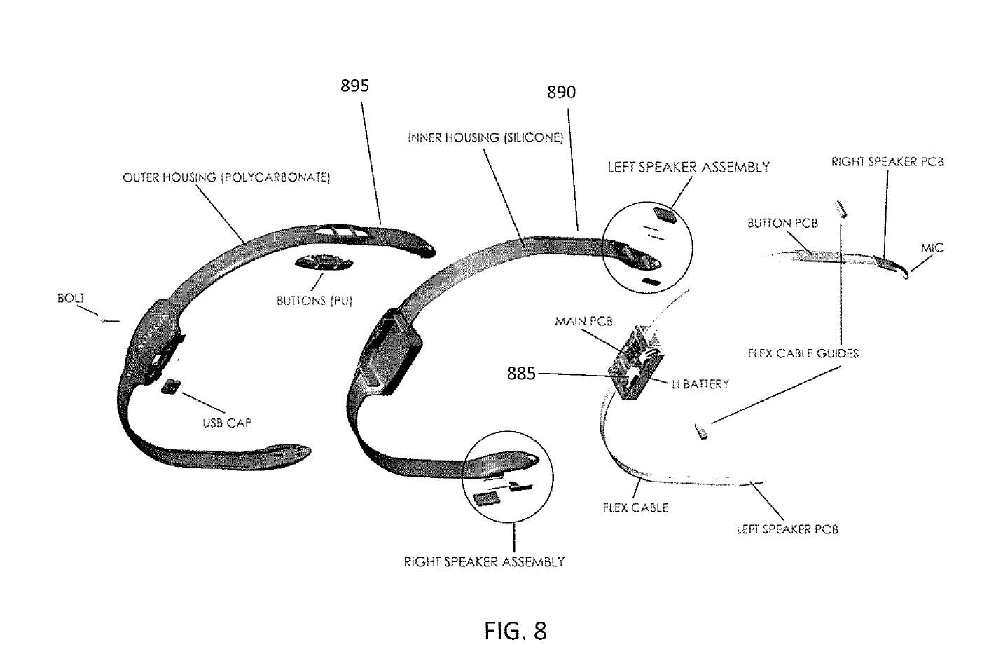

Another embodiment of the speaker system is shown in FIG. 8. This embodiment is similar to the embodiments discussed above. In this embodiment, the outer housing 895 is made from polycarbonate material and the inner housing 890 is made of a silicone material. In other embodiments the outer housing is made of a material that is similarly impact resistant to polycarbonate material. In other embodiments the inner housing 890 is made of similarly flexible and/or soft material to silicone material. This embodiment also includes a USB port 885 in the electronics package. A portable audio device can be connected by wire through the USB port 885 rather than by using a Bluetooth or other wireless connection. In some embodiments the USB port 885 is substituted or supplemented with a 3.5 mm audio jack, another type of wired audio connection, or a combination of two or more of these (not shown).

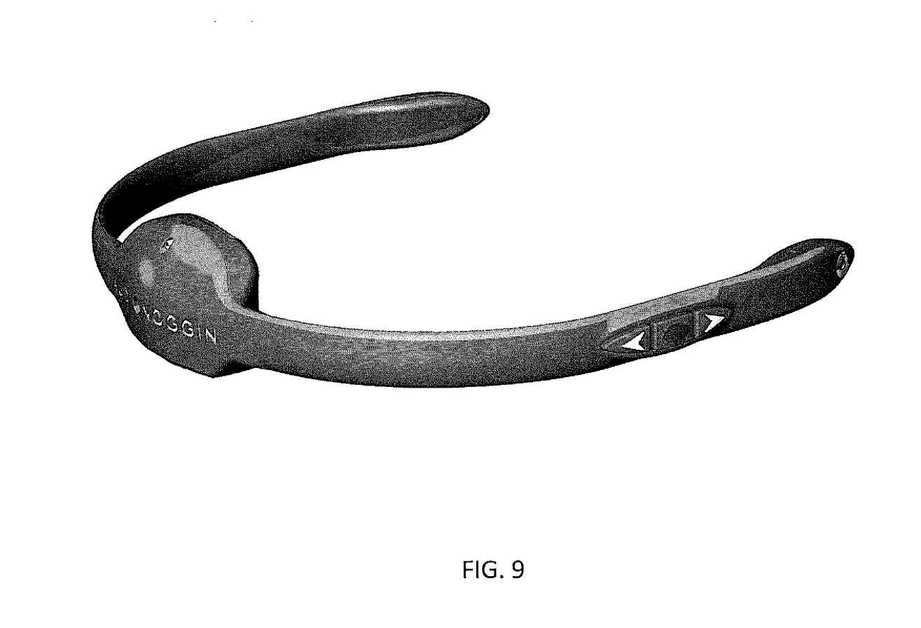

Another embodiment of the speaker system is shown in FIG. 9, in completely assembled form.

What is claimed is:

1. A speaker system for use with a wireless transmitter comprising:
a wireless receiver that receives digitized audio signals from the wireless transmitter;
one or more side-firing speakers for positioning generally above a wearer's ear and proximate to the side of the wearer's head wherein the side-firing speakers, when positioned is such a manner, has a depth dimension along an axis generally perpendicular to the side of the wearer's head and height and width dimensions generally along axes perpendicular to each other and the axis generally perpendicular to the side of the wearer's head, the depth dimension being substantially less than the height and width dimensions and wherein the sound emanates from the side-firing speaker primarily from a port generally perpendicular to the axis generally perpendicular to the side of the wearer's head;
an audio processor, that receives the digital audio signals from the wireless transmitter and converts the digital audio signals into analog audio signals, the audio processor further connected to the one or more side-firing speakers such that the analog audio signals are supplied to the side-firing speakers;
one or more fasteners connected to the one or more side-firing speakers that attach the side-firing speakers to headgear worn by the wearer.

2. The speaker system of claim 1 wherein the wireless receiver is a Bluetooth receiver.

3. The speaker system of claim 1 wherein the fasteners attach the side-firing speakers to a bicycle helmet.

4. The speaker system of claim 1 wherein the fasteners attach the side-firing speakers to a hat.

5. The speaker system of claim 1 wherein the fasteners attach the side-firing speakers to a motor vehicle helmet.
